(19) United States
(12) Patent Application Publication
(10) Pub. No.: US 2006/0250571 A1
(43) Pub. Date: Nov. 9, 2006

(54) Spectacle set with multiple decorative frame

(76) Inventor: Xin Liang Li, Pomona, CA (US)

Correspondence Address: Raymond Y. Chan;Suite 128, 108 N. Ynez Avenue, Monterey Park, CA, 91754, US

(21) Appl. No.: 11/482,282

(22) Filed: Jul. 9, 2006

Related U.S. Application Data
(62) Division of application No. 11/004,112, filed on Dec. 3, 2004.
(60) Provisional application No. 60/608,629, filed on Sep. 10, 2004.

(51) Int. Cl. G02C 11/02

(52) U.S. Cl. 351/52

(57) ABSTRACT

A spectacle set includes at least a decorative frame for supporting two lenses in position. The decorative frame includes two lens rims which are shaped and sized corresponding to the lenses, a bridge extended between two inner sides of the lens rims, two side extensions provided at two outer sides of the lens rims for coupling a pair of temples respectively, and a securing device detachably mounting the two lenses on the lens rims respectively in a toolless manner.

### CROSS REFERENCE OF RELATED APPLICATION

This is a divisional application that claims the benefit of priority under 35 U.S.C.§119 to a non-provisional application, application Ser. No. 11/004,112 filed Dec. 3, 2004, which is non-provisional application of a provisional application, application No. 60/608,629 filed Sep. 10, 2004.

### BACKGROUND OF THE PRESENT INVENTION

1. Field of Invention

The present invention relates to spectacles, and more particularly to a spectacle set which comprises at least a decorative frame detachably mounting two lenses in position so as to allow the wearer to interchange the spectacle frame.

2. Description of Related Arts

A conventional spectacle generally comprises two lenses and a spectacle frame for supporting the lenses in position, wherein the spectacle frame comprises two side extensions rearwardly extended from two outer sides of the lenses respectively for wearing onto the ears of the user, and a bridge extended between two inner sides of the lenses for supporting the lenses at a predetermined position above the user's nose.

Specifically, the spectacle frame comprises two lens rims for respectively encircling the two lenses wherein the bridge is extended between two inner sides of the lens rims and the two side extensions are respectively extended from two outer sides of the lens rims.

As a matter of fact, the two lenses are securely mounted within the two lenses respectively such that the two lenses are permanently affixed to the spectacle frame. However, such structural configuration of the spectacle frame has several drawbacks.

Nowadays, most spectacle designers design different ornamental designs of the spectacles to enhance the aesthetic appearance thereof since spectacles are considered as one of the fashionable objects for the wearers. Therefore, most wearers usually purchase more than one spectacles to mix and match with their fashionable style. It is worth to mention that such spectacles are prescription glasses such that optometrists suggest that every wearer should have an eye examination for every two years. It is costly that the wearers must pay for another set of fashionable spectacles once the prescription glasses must be changed.

Furthermore, the conventional spectacle is difficult to clean in detail since the lenses are permanently affixed to the spectacle frame. Accordingly, the wearer can only clean up the two surfaces of each of the lenses by rubbing since the encircling edge of each lens is mounted at the lens rim. Therefore, the dirt will be accumulated within a gap between the encircling edge of the lens and the lens rim. However, when the wearer tries to clean the dirt within the gap, the lens may be forced to detach from the spectacle frame accidentally and even the structure of the spectacle frame will be distorted. Due to the precise configuration of the spectacle frame, the lens cannot be tightly secured to the spectacle frame again once the lens is detached from the spectacle frame.

### SUMMARY OF THE PRESENT INVENTION

A main object of the present invention is to provide a spectacle set which comprises at least a decorative frame detachably mounting two lenses in position so as to allow the wearer to interchange the decorative frame.

Another object of the present invention is to provide a spectacle set, wherein the lenses are securely mounted to the decorative frame in a toolless manner. In other words, no tool is required to detachably mount the lenses to the decorative frame.

Another object of the present invention is to provide a spectacle set, which does not need to alter its original structural design for fitting the lenses. In other words, from the user's perspective, the cost for utilizing the decorative frame can be minimized.

Another object of the present invention is to provide a spectacle set, wherein the detachably mounting operation of the lens is simple that the wearer is able to complete the operation in minutes.

Another object of the present invention is to provide a spectacle set, wherein no expensive or complicated mechanical structure is required to employ in the present invention in order to achieve the above mentioned objects. Therefore, the present invention successfully provides an economic and efficient solution not only for providing a decorative frame to substantially support the lenses in position but also for configuring an interchangeable decorative frame that the wearer is able to interchange the decorative frame to fit the lens, especially for the prescription glasses.

Accordingly, in order to accomplish the above objects, the present invention provides a spectacle set which comprises at least a decorative frame for supporting two lenses in position. The decorative frame comprises two lens rims which are shaped and sized corresponding to the lenses, a bridge extended between two inner sides of the lens rims, two side extensions provided at two outer sides of the lens rims for coupling a pair of temples respectively, and a free-hand securing device detachably mounting the two lenses on the lens rims respectively in a toolless manner.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a spectacle set according to a first preferred embodiment of the present invention.

FIG. 2 is a partially perspective view of the spectacle set according to the above first preferred embodiment of the present invention.

FIG. 3 illustrates an alternative mode of the securing device of the spectacle set according to the above first preferred embodiment of the present invention.

FIG. 4 is a perspective view of a spectacle set according to a second preferred embodiment of the present invention.

FIG. 5 is a sectional view of the spectacle set according to the above second preferred embodiment of the present invention.

FIG. 6 is a perspective view of a spectacle set according to a third preferred embodiment of the present invention.

FIG. 7 is a sectional view of the spectacle set according to the above third preferred embodiment of the present invention.

FIG. 8 illustrates an alternative mode of the spectacle set according to the above third preferred embodiment of the present invention.

FIG. 9 is a perspective view of a spectacle set according to a fourth preferred embodiment of the present invention.

FIG. 10 is a perspective view of a spectacle set according to a fifth preferred embodiment of the present invention.

FIGS. 11A and 11B are sectional view of the securing device of the spectacle set according to the above fifth preferred embodiment of the present invention.

FIG. 12 is a perspective view of a spectacle set according to a sixth preferred embodiment of the present invention.

FIGS. 13A and 13B are perspective views of the securing device of the spectacle set according to the above sixth preferred embodiment of the present invention.

FIG. 14 is a perspective view of a spectacle set according to a seventh preferred embodiment of the present invention.

FIG. 15 is a sectional view of the securing device of the spectacle set according to the above seventh preferred embodiment of the present invention.

FIG. 16 is a perspective view of a spectacle set according to an eighth preferred embodiment of the present invention.

FIG. 17 is a sectional view of the securing device of the spectacle set according to the above eighth preferred embodiment of the present invention.

FIG. 18 illustrates an application of the spectacle set according to the above first through eighth embodiments of the present invention.

FIG. 19 illustrates another application of the spectacle set according to the above first through eighth embodiments of the present invention.

### DETAILED DESCRIPTION OF THE PREFERRED EMBODIMENT

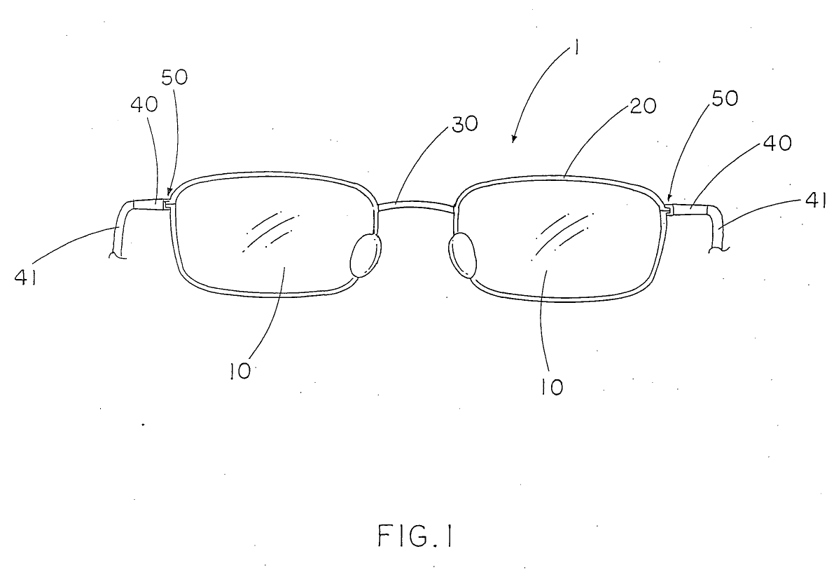

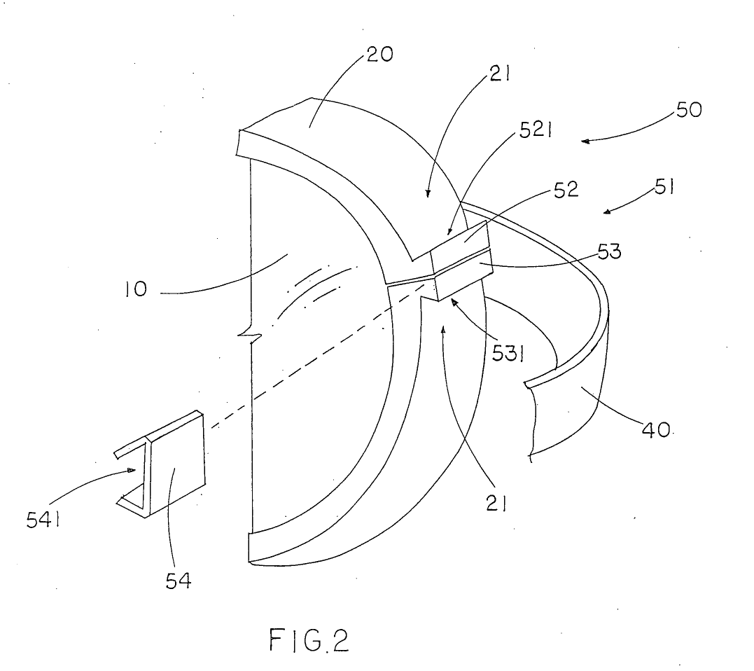

Referring to FIGS. 1 to 2 of the drawings, a spectacle set according to a first embodiment of the present invention is illustrated, wherein the spectacle set comprises at least a decorative frame 1 for supporting two lenses 10 in position.

The decorative frame 1 comprises two lens rims 20, a bridge 30 extended between two inner sides of the lens rims 20, two side extensions 40 provided at two outer sides of the lens rims 20 for coupling a pair of temples 41 respectively, and a free-hand securing device 50 detachably mounting the two lenses 10 on the lens rims 20 respectively in a toolless manner.

According to the first embodiment, each of the lens rims 20 is shaped and sized corresponding to the lens 10 wherein each of the lens rims 20 having a C-shape has two free ends 21 arranged in such a manner that when the two free ends 21 are aligned with each other, the lens rim 20 form a circular structure to encircle a peripheral edge of the respective lens 10. The securing device 50 is provided at the free ends 21 of each of the lens rims 20 to connect said the free ends 21 of the lens rim 20 to form the circular structure. Preferably, the two free ends 21 of each of the lens rims 20 are formed at the outer side thereof at a position aligning with the respective side extension 40 so as to enhance the aesthetic appearance of the decorative frame 1.

As shown in FIG. 2, the securing device 50 comprises a rim lock 51 having an upper locking body 52 provided at one of the free ends 21 of the lens rim 20 and a lower locking body 53 provided at another free end 21 of the respective lens rim 20, and a detachable locker 54 slidably fastened the upper locking body 52 with the lower locking body 53 in a detachably connecting manner so as to connect the two free ends 21 of the lens rim 20.

Accordingly, the detachable locker 54 having a C-shaped cross section has a mounting groove 541 wherein the upper and lower locking bodies 52, 53 of the rim lock 51 are fittingly received in the mounting groove 541 to connect the two free ends 21 of the lens rim 20 to form the circular structure so as to retain the respective lens 10 in position. In other words, when the upper locking body 52 is overlapped on the lower locking body 53, the detachable locker 54 is transversely slid to engage with the rim lock 51 to receive the upper and lower locking bodies 52, 53 within the mounting groove 541.

The upper locking body 52 has an upper slanted surface 521 and the lower locking body 53 has a lower slanted surface 531 such that when the upper locking body 52 is overlapped on the lower locking body 53, a thickness of the rim lock 51 is gradually reduced towards the lens rim 20. As shown in FIG. 2, the mounting groove 541 of each of the detachable lockers 54 has a width gradually reducing towards an opening thereof to fit the rim lock 51 in the mounting groove 541 of the detachable locker 54.

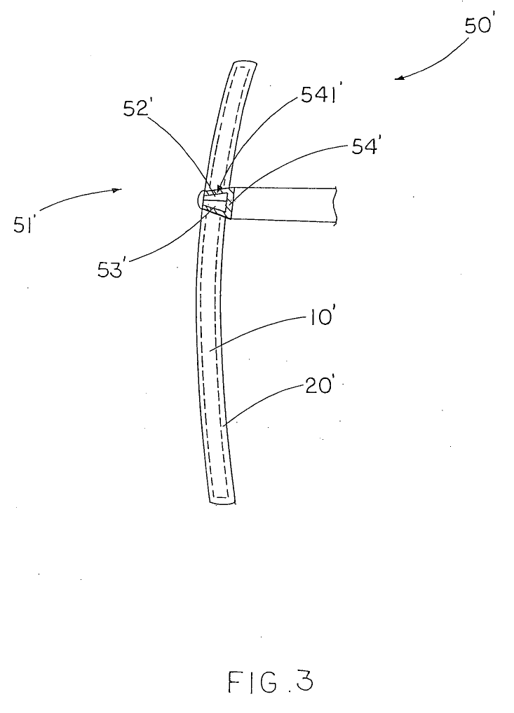

FIG. 3 illustrates an alternative mode of the securing device 50′ wherein the upper locking body 52′ is overlapped on the lower locking body 53′ to form the rim lock 51′ having a thickness gradually reducing from a rear end to a front end. The mounting groove 541′ of the detachable locker 54′ has a width gradually towards a front opening such that the detachable locker 54′ is sidewardly slid to engage with the rim lock 51′ to receive the upper and lower locking bodies 52′, 53′ within the mounting groove 541′ so as to hold the lens 10′ within the respective lens rim 20′.

It is worth to mention that the upper locking body 52 can be overlapped with the lower locking body 53 side-by-side such that the detachable 54 is downwardly slid to engage with the rim lock 51 to receive the upper and lower locking bodies 52, 53 within the mounting groove 541.

In order to securely mount the lenses 10 to the decorative frame 1, the wearer is able to encirlingly position two lenses 10 within the lens rims 20 respectively wherein a pressing force is applied at the two free ends 21 of each of the lens rims 20 until the upper locking body 52 is overlapped the lower locking body 53. Therefore, the wearer is able to slide the detachable locker 54 to receive the rim lock 51 therein to securely connect the two free ends 21 of the lens rim 20 with each other to form the circular structure so as to substantially encircle the peripheral edge of the respective lens 10 within the lens rim 20. In other words, the wearer is able to interchange the decorative frame 1 without replacing the lenses 10, especially for prescription glasses. Accordingly, the wearer can own two or more decorative frames 1 with different styles such that the wear is able to interchange the decorative frames 1 with the same lenses 10 incorporating therewith.

For detaching the lenses 10 from the decorative frame 1, the wearer can simply slide the detachable locker 54 to release the engagement between the upper and lower locking bodies 52, 53 such that the free ends 21 of the lens rim 20 are free to move for detaching the respective lens 10 from the lens rim 20. It is worth to mention that no tool, such as screw driver, is required to secure the lenses 10 to or detach the lenses 10 from the decorative frame 1 through the sliding engagement between the rim lock 51 and the detachable locker 54. Once the lens 10 is detached from the decorative frame 1, the wearer is able to clean the lenses 10 and the decorative frame 1 individually without distorting the structure of the decorative frame 1.

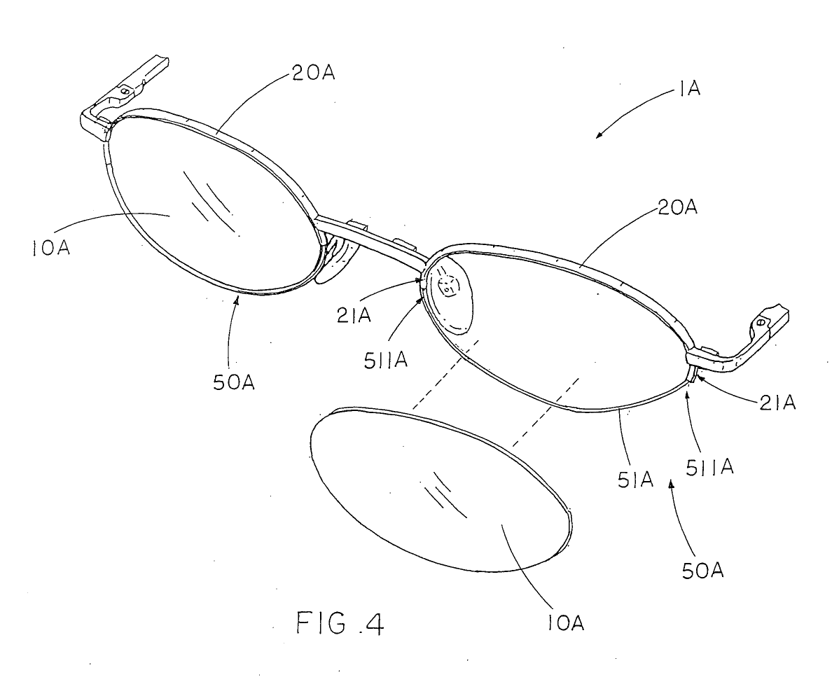

As shown in FIG. 4, a decorative frame 1A of a second embodiment illustrates an alternative mode of the first embodiment of the present invention, wherein each of the lens rims 20A having a C-shape has two free ends 21A to encircle a portion of a peripheral edge of the respective lens 10A.

The securing device 50A comprises an elastic fastening string 51A having two securing ends 511 substantially fastening at the two free ends 21A of each of the lens rims 20A for applying an urging force against the peripheral edge of the respective lens 10A so as to form a circular structure to encircle the peripheral edge of the respective lens 10A.

As shown in FIG. 4, each of the lens rims 20A forms an upper rim to encircle an upper peripheral edge of the respective lens 10A and the elastic fastening string 51A fastened with the respective lens rim 20A to form a lower rim to apply the urging force against a lower peripheral edge of the respective lens 10A so as to encircle the lower peripheral edge of the respective lens 10A.

Accordingly, the elastic fastening string 51A is made of elastic material adapted to stretchably extend a length between the two securing ends 511A of the elastic fastening string 51A so as to adjust a circumferential size of the circular structure.

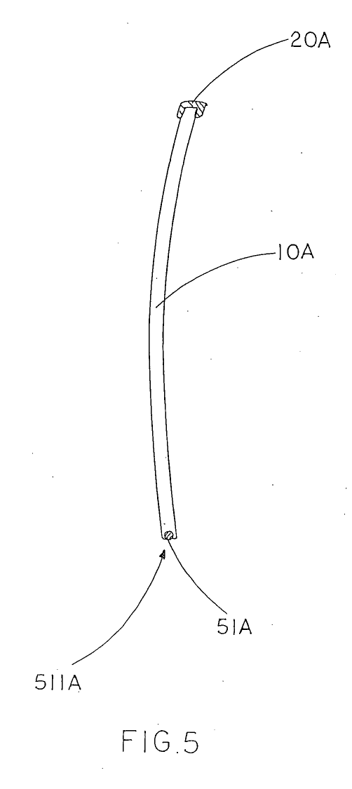

Each of the lenses 10A further has a retaining groove 11A formed along the lower peripheral edge of the lens 10A wherein the elastic fastening string 51A is slidably received in the retaining groove 11A to substantially retain the lens 10A in position, as shown in FIG. 5. In other words, when the elastic fastening string 51A received along the retaining groove 11A, the elastic fastening string 51A substantially encircles the lower peripheral edge of the lens 10A.

In order to securely mount the lenses 10A to the decorative frame 1A, the wearer is able to fit the upper peripheral edge of the lens 10A to the respective lens rim 20A and to apply a pulling force at the elastic fastening string 51A to stretch the length thereof so as to encircle the lower peripheral edge of the lens 10A. In other words, each of the lenses 10A is encircled within the respective lens rim 20A and the elastic fastening string 51A. Therefore, no tool is required to mount the lenses 10A onto or detach the lenses 10A from the decorative frame 1A through the elastic engagement of the elastic fastening string 51A.

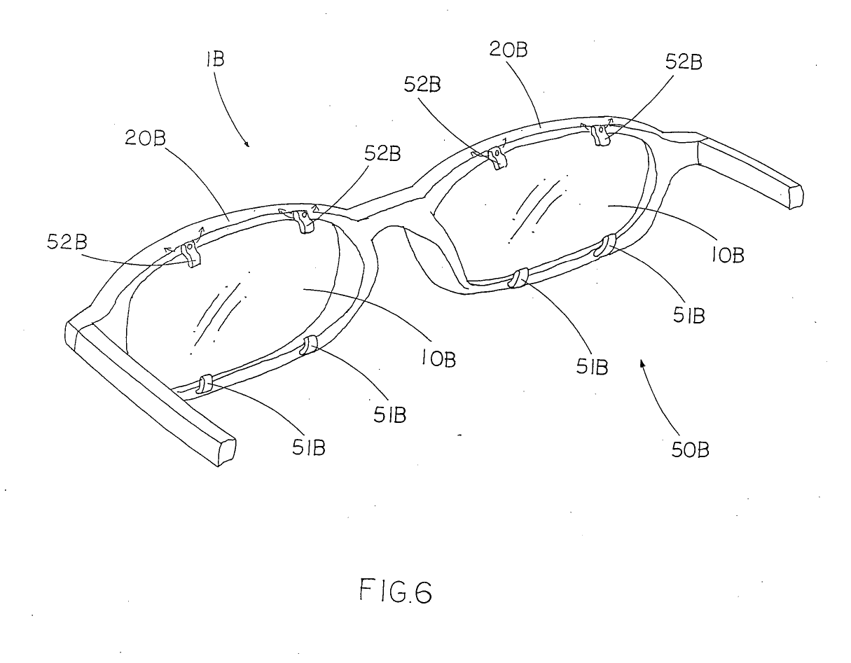

As shown in FIG. 6, a decorative frame 1B of a third embodiment illustrates another alternative mode of the first embodiment of the present invention, wherein each of the lens rims 20B is shaped and sized corresponding to the lens 10B such that each of the lens rims 20B forms a circular structure to encircle the respective lens 10B.

The securing device 50B comprises at least a supporting member 51B upwardly extended at a lower portion of each of the lens rims 20B for supporting a lower peripheral edge of the lens 10B and at least a retaining member 52B pivotally formed at an upper portion of each of the lens rims 20B for retaining an upper peripheral edge of the lens 10B in position, so as to substantially encircle the lens 10B within the respective lens rim 20B.

Preferably, two supporting member 51B are rearwardly and spacedly extended from a rear side of the respective lens rim 20B at the lower portion thereof and two retaining member 52B are rearwardly and spacedly extended from the rear side of the respective lens rim 20B at the upper portion thereof, as shown in FIG. 6.

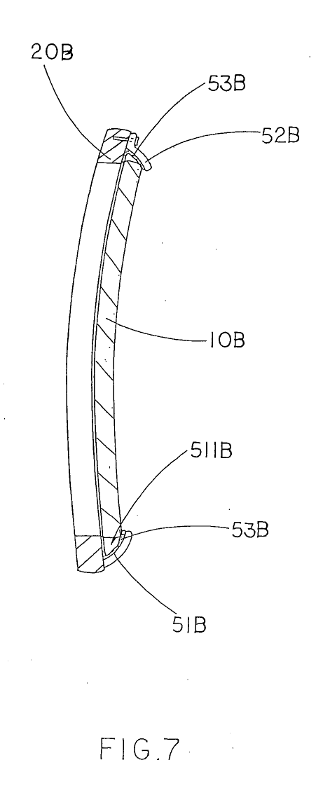

Accordingly, the supporting member 51B is rearwardly extended from the rear side of the respective lens rim 20B to define a supporting groove 511B between the supporting member 51B and the rear side of the lens rim 20B for the lower peripheral edge of the lens 10B receiving in the supporting groove 511B. The supporting member 51B is inclinedly extended from the rear side of the lens rim 20B such that a width of the supporting groove 511B is gradually increasing towards an upper opening thereof, as shown in FIG. 7. Therefore, the lenses 20B with varying thicknesses can fit into the supporting groove 511B without altering the structure of the supporting member 51B.

The retaining member 52B is pivotally mounted to the rear side of the respective lens rim 20B at the upper portion thereof, wherein the retaining member 52B is adapted to pivotally fold to bias against the upper peripheral edge of the lens 10B at a rear side thereof to substantially hold the lens 10B at the lens rim 20B and to pivotally fold offset to the upper peripheral edge of the lens 10B such that the lens 10B is adapted to be detached from the lens rim 20B.

The securing device 50B further comprises a protective layer 53B formed at an inner side of each of the supporting member 51B and the retaining member 52B to protect the peripheral edge of the lens 10B. Accordingly, when the lens 10B is mounted at the respective lens rim 20B, the supporting member 51B and the retaining member 52B may scratch on the lens 10B accidentally during the mounting operation. The protective layer 53B, which is made of anti-scratching material such as rubber or plastic, is formed at each inner side of the supporting member 51B and the retaining member 52B to prevent the lens 10B from being scratched by the supporting member 51B and the retaining member 52B. In addition, the protective layer 53B can also provide a friction between the lens 10B and the lens rim 20B to substantially hold the lens 10B in position.

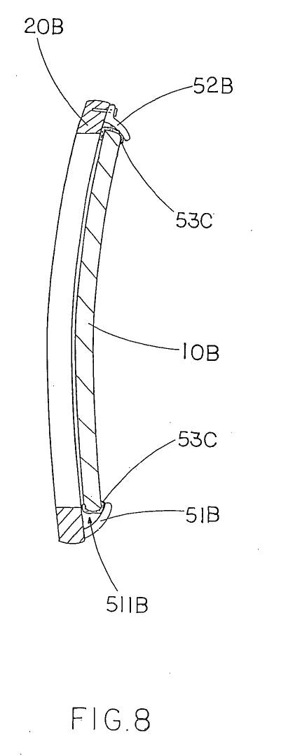

FIG. 8 illustrates an alternative mode of the protective layer 53C which encircles around the peripheral edge of the lens 10B such that when the lens 10B is mounted to the respective lens rim 20B, the protective layer 53C prevents the lens 10B from being scratched by the supporting member 51B and the retaining member 52B.

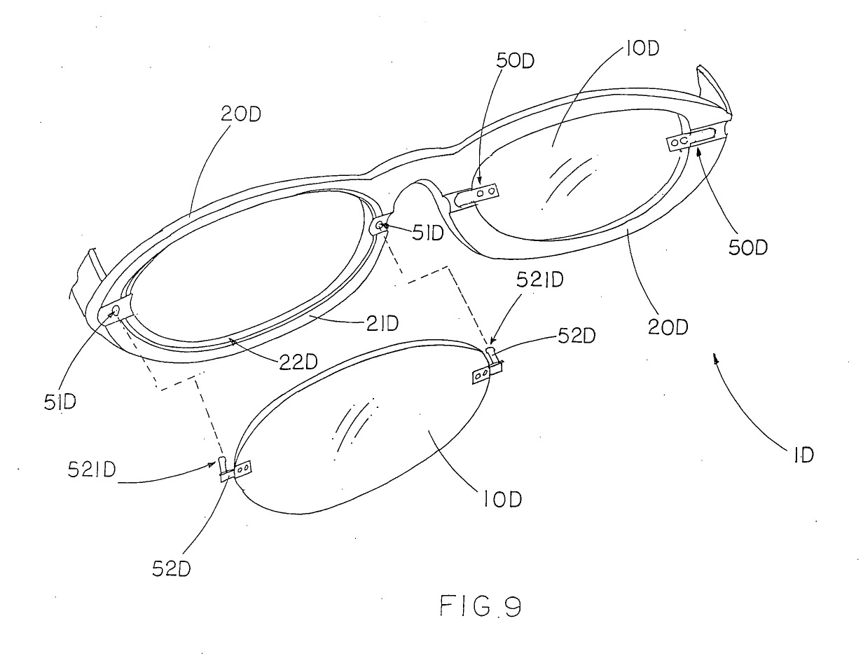

As shown in FIG. 9, a decorative frame 1D of a fourth embodiment illustrates another alternative mode of the first embodiment of the present invention, wherein each of the lens rims 20D is shaped and sized corresponding to the lens 10D such that each of the lens rims 20D forms a circular structure to encircle the respective lens 10D. Each of the lens rims 20D having a L-shape cross section has a surrounding rim 21D encircling a peripheral edge of the respective lens 10D and a retaining rim 22D biasing against a rear side of the respective lens 10D.

The securing device 50D contains two holding grooves 51D formed on the inner side and the outer side of each of the lens rims 20D respectively and comprises two fastening elements 52D rearwardly extended from the inner side and the outer side of each of the lens 10D to align with the two holding grooves 51D respectively, wherein when the four fastening elements 52D are slidably inserted into the four holding grooves 51D respectively in a detachably connecting manner, the two lens 10D are securely mounted at the two lens rims 20D respectively.

Accordingly, each of the fastening elements 52D is directly fastened at the peripheral edge of the lens 10D to align with the respective holding groove 51D on the lens rim 20D, wherein each of the fastening elements 52D, which is made of elastic material, has an enlarged head portion 521D having a size slightly larger than a size of the holding groove 51D such that when the head portions 521D of the fastening elements 52D are slidably pressed into the holding grooves 51D respectively, the lenses 10D are substantially mounted at the lens rims 20D in position. It is worth to mention that the wearer is able to apply a pulling force at the lens 10D to slidably pull the head portion 521D of the fastening element 52D out of the respective holding groove 51D so as to detach the lens 10D from the lens rim 20D.

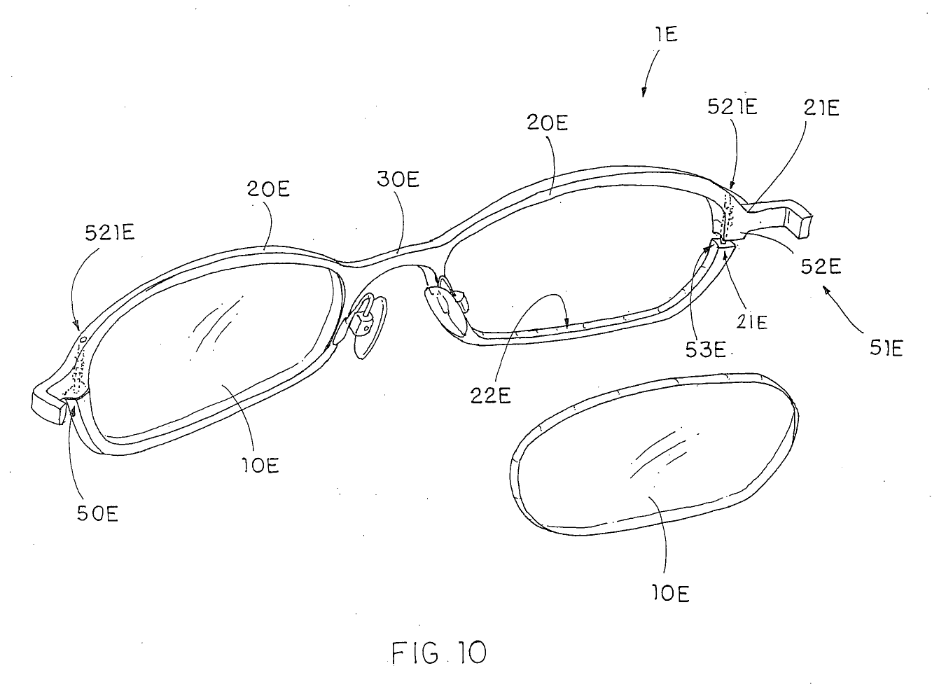

As shown in FIG. 10, a spectacle set of a fifth embodiment illustrates another alternative mode of the first embodiment of the present invention, wherein the spectacle set comprises at least a decorative frame 1E for supporting two lenses 10E in position. The decorative frame 1E comprises two lens rims 20E and a bridge 30E extended therebetween, wherein each of the lens rims 20E having a C-shape has two free ends 21E arranged in such a manner that when the two free ends 21E are aligned with each other, the lens rim 20E form a circular structure to encircle a peripheral edge of the respective lens 10E.

The securing device 50E is provided at the free ends 21E of each of the lens rims 20E to connect said the free ends 21E of the lens rim 20E to form the circular structure. Preferably, the two free ends 21E of each of the lens rims 20E are formed at the outer side thereof at a position aligning with the respective side extension 40E so as to enhance the aesthetic appearance of the decorative frame 1E.

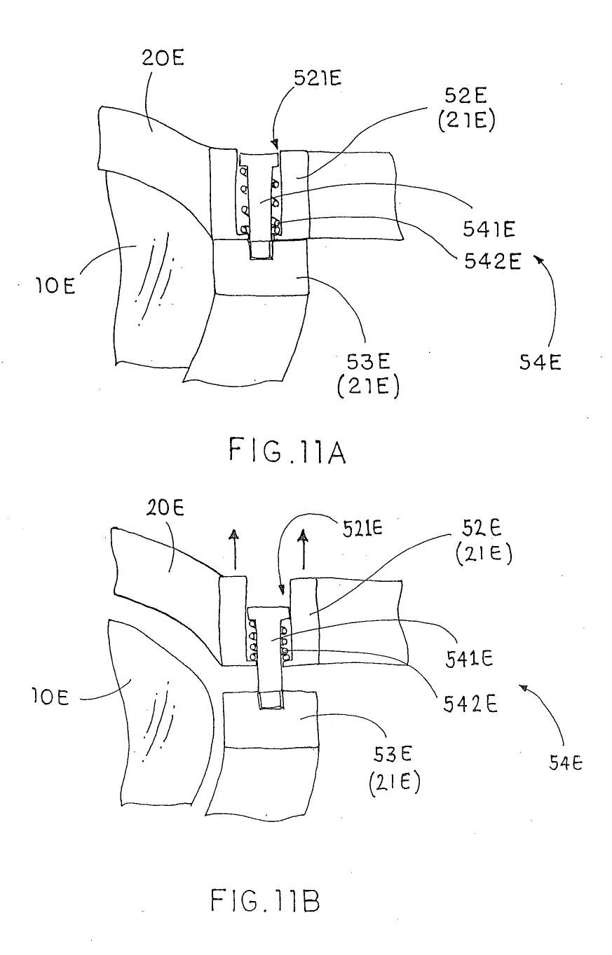

As shown in FIG. 11A, the securing device 50E comprises a rim lock 51E having an upper locking body 52E provided at one of the free ends 21E of the lens rim 20E and a lower locking body 53E provided at another free end 21E of the respective lens rim 20E, and a slider locker 54E affixed to the lower locking body 53E to slidably engage with the upper locking body 52E so as to connect the two free ends 21E of the lens rim 20E.

Accordingly, the upper locking body 52E, which is integrally extended from the respective free end 21E of the rim lock 20E, has a sliding slot 521E extending towards to the lower locking body 53E, wherein the slider locker 54E comprises a locker pin 541E having an enlarged head slidably disposed in the sliding slot 521E and an affixed end affixed to the lower locking body 53E, and a resilient element 542E disposed in the sliding slot 521E for applying an urging force against the enlarged head of the locker pine 541E to push the lower locking body 53E towards the upper locking body 52E so as to connect the two free ends 21E of the lens rims 20 to hold the lens 10E in position.

The resilient element 542E is embodied as a compression spring disposed in the sliding slot 521E of the upper locking body 52E wherein the resilient element 542E has two ends biasing against the enlarged head of the locker pin 541E and a bottom wall of the sliding slot 521E to normally push the lower locking body 53E towards the upper locking body 52E. Accordingly, in order to detach the lens 10E from the respective lens frame 20E, the user is able to stretch the lens frame 20E to pull the upper locking body 52E apart from the lower locking body 53E while the enlarged head of the locker pin 541E is slid into the sliding slot 521E to compress the resilient element 542E as shown in FIG. 11B.

Accordingly, each of the lens rims 20E further has a holding groove 22E formed along an inner peripheral edge thereof to receive the peripheral edge of the respective lens 10E when the lens 10E is retained within the lens rims 20E.

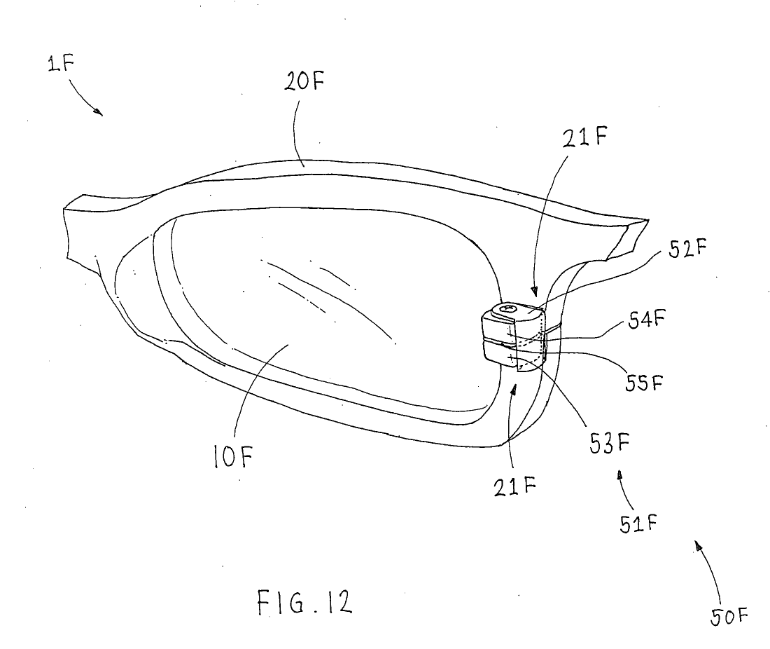

As shown in FIG. 12, a spectacle set of a sixth embodiment illustrates another alternative mode of the first embodiment of the present invention, wherein the decorative frame 1F, having the same structure of the first embodiment expect the securing device 50F, comprises two lens rims 20F to hold the lenses 10F in position.

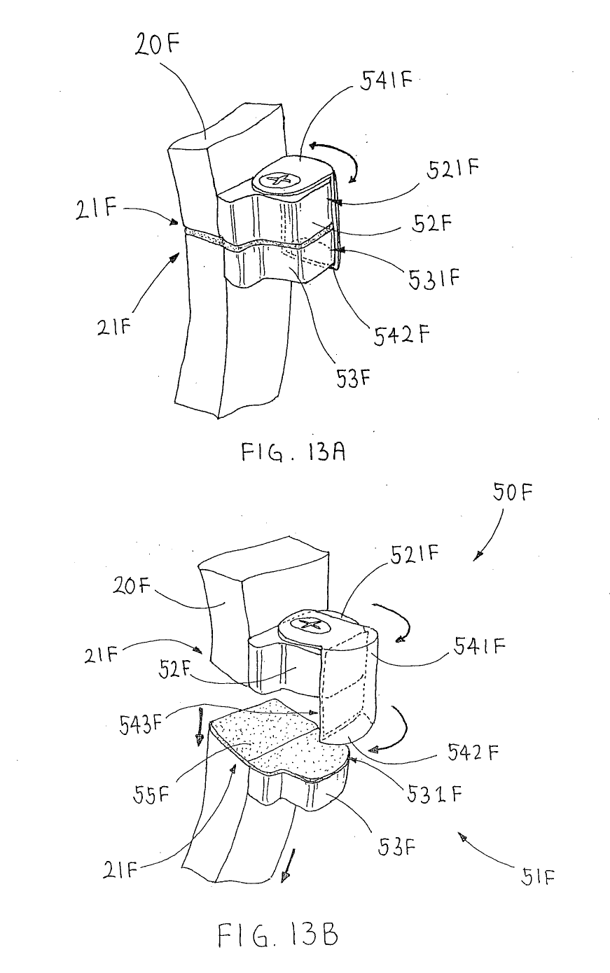

The securing device 50F is provided at the free ends 21F of each of the lens rims 20F to connect said the free ends 21F of the lens rim 20F to form the circular structure. As shown in FIG. 13, the securing device 50F comprises a rim lock 51F having an upper locking body 52F provided at one of the free ends 21F of the lens rim 20F and a lower locking body 53F provided at another free end 21F of the respective lens rim 20F, and a slider locker 54F affixed to the upper locking body 52F to slidably engage with the lower locking body 53F so as to connect the two free ends 21F of the lens rim 20F.

According to the sixth embodiment, the slider locker 54F comprises a top platform 541F rotatably mounted on the upper locking body 52F and a bottom platform 542F defining a locking cavity 543F between the top and bottom platforms 541F, 542F wherein the slider locker 54F is rotatably slid to lock up the upper locking body 52F with the lower locking body 53F when the bottom platform 542F is slid to engage with the lower locking body 53F to receive the upper and lower locking bodies 52F, 53F within the locking cavity 543F, as shown in FIGS. 13A and 13B.

As shown in FIG. 13A, the upper locking body 52F has an upper protrusion portion 521F and the lower locking body 53F has a lower protrusion portion 531F shaped and sized corresponding to the upper protrusion portion 521F wherein the slider locker 54F is slid to receive the upper and lower protrusion portions 521F, 531F within the locking cavity 543F to lock up the upper locking body 52F with the lower locking body 53F.

The securing device 50F further comprises a reinforcing layer 55F sandwiched between the upper and lower locking bodies 52F, 53F to reinforce an engagement therebetween. Accordingly, the reinforcing layer 55F is made of rubber or plastic to prevent an unwanted movement of each of upper and lower locking bodies 52F, 53F when the slider locker 541F is rotatably slid to lock up the upper locking body 52F with the lower locking body 53F so as to prevent the lens 10F from being scratched by the rim lock 51F accidentally.

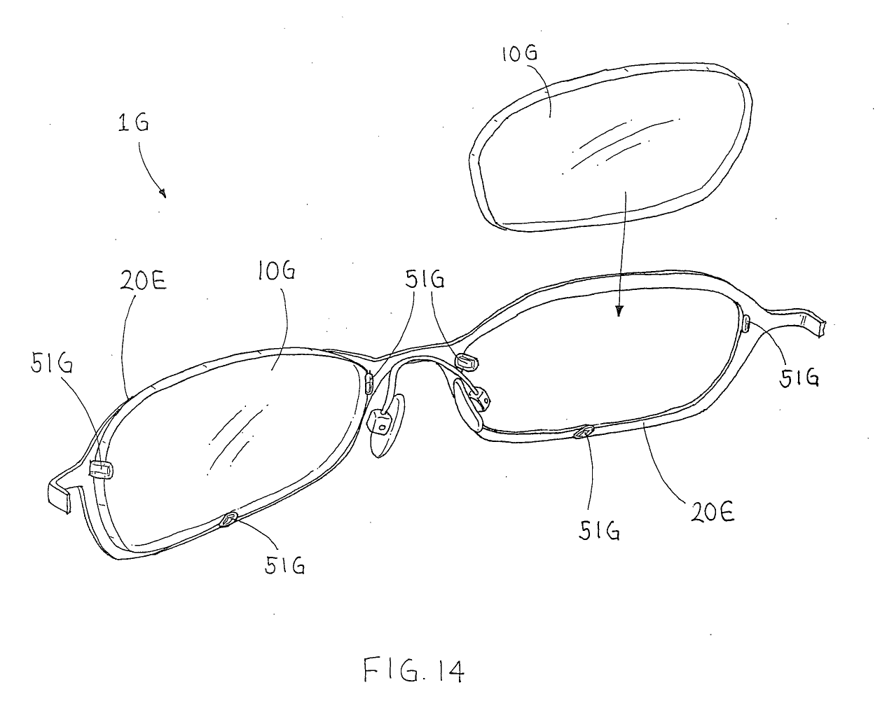

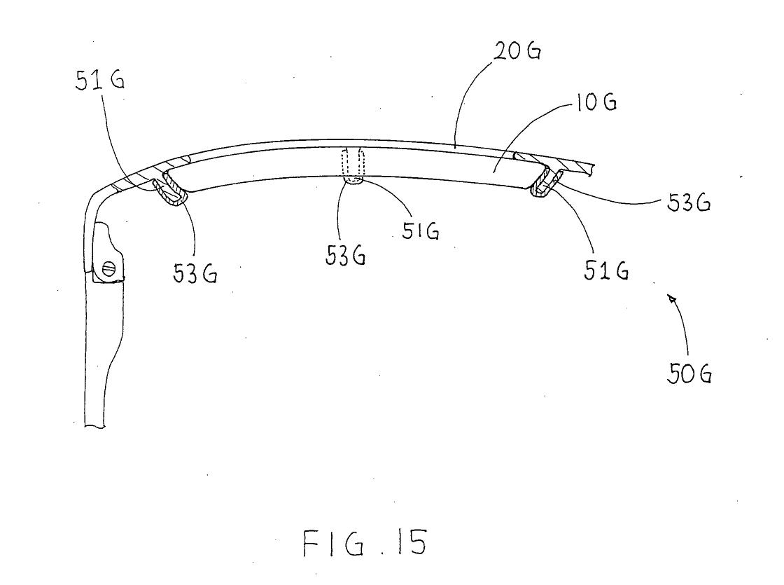

As shown in FIGS. 14 and 15, a spectacle set of a seventh embodiment illustrates another alternative mode of the third embodiment of the present invention, wherein the decorative frame 1G, having the same structure of the first embodiment expect the securing device 50G, comprises two lens rims 20G to hold the lenses 10G in position.

The securing device 50G comprises at least three supporting members 51G providing at two side peripheral edges and a lower peripheral edge of each of the lens rims 20G respectively wherein the supporting members 51G are inwardly extended from the rear side of the lens rim 20G to securely hold the respective lens 10G within the lens rim 20G. Accordingly, the three supporting members 51G are biased against two side peripheral edges and a lower peripheral edge of the respective lens 10G such that the lens 10G can be dropped down and mounted within the lens rim 20G to enhance the mounting operation of the lens 10G.

The securing device 50G further comprises a protective layer 53G formed at an inner side of each of the supporting members 51G to protect the peripheral edge of the lens 10G, as shown in FIG. 15.

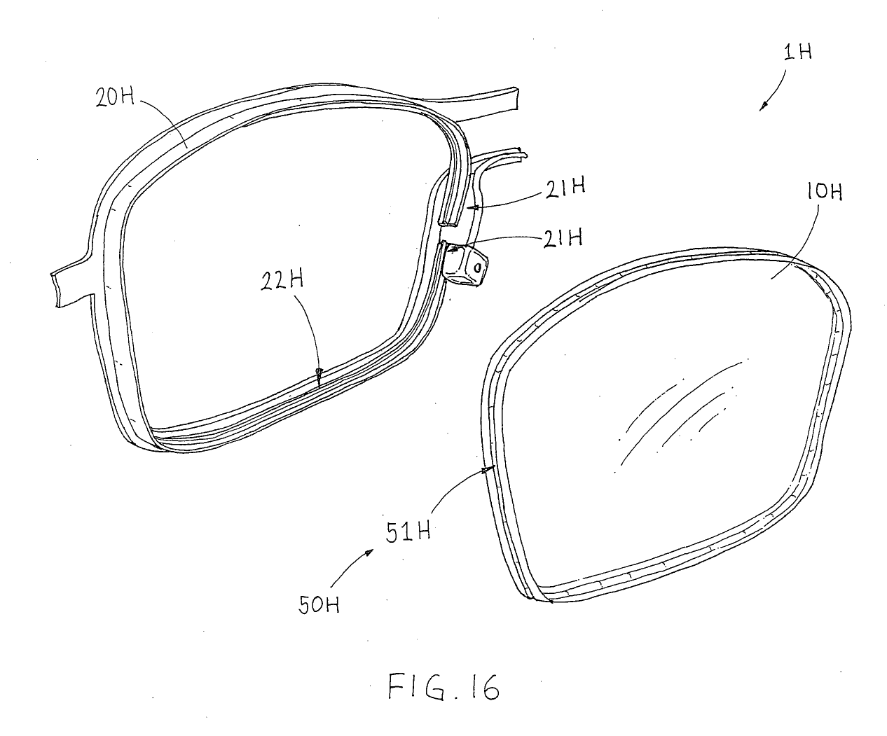

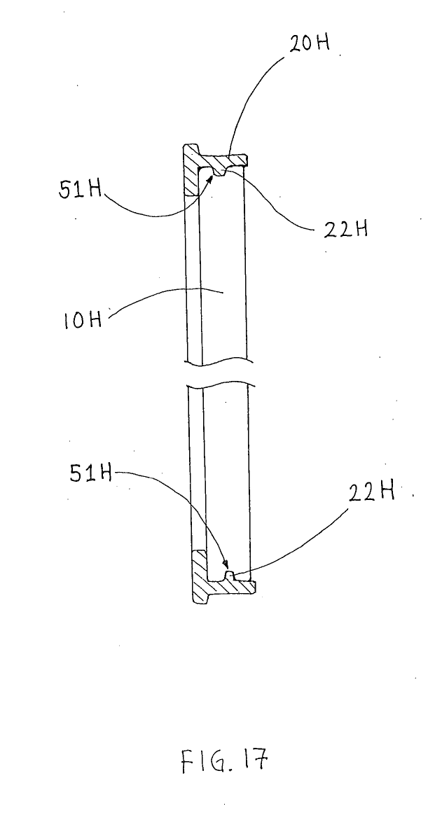

As shown in FIGS. 16 and 17, a spectacle set of an eighth embodiment illustrates another alternative mode of the fourth embodiment of the present invention, wherein the decorative frame 1H, having the same structure of the first embodiment expect the securing device 50H, comprises two lens rims 20H to hold the lenses 10H in position.

Each of the lens rims 20H having a C-shape has two free ends 21H arranged in such a manner that when the two free ends 21H are aligned with each other, the lens rim 20H form a circular structure to encircle a peripheral edge of the respective lens 10H.

Each of the lens rims 20H is shaped and sized corresponding to the lens 10H such that each of the lens rims 20H forms a circular structure to encircle the respective lens 10H. Each of the lens rims 20H having a L-shape cross section has a surrounding rim 22H encircling a peripheral edge of the respective lens 10H.

The securing device 50H contains a holding groove 51H formed along a peripheral edge of each of the lenses 10H, wherein the surrounding rim 22H is fittingly engaged in the respective holding groove 51H, as shown in FIG. 17, so as to mount the lens 10H within the respective lens rim 20H. Accordingly, each of the lens rims 20H can be slightly stretched to expand the size of the lens rim 20H such that the lens 10H is adapted to fit into the respective lens rim 20H to engage the surrounding rim 52H with the holding groove 51H.

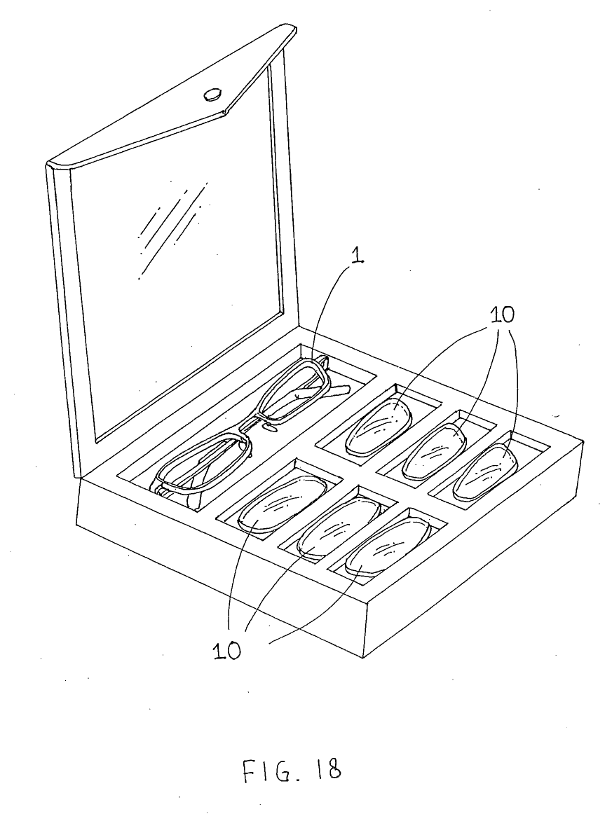

As shown in FIG. 18, the spectacle set of the present invention forms a lens interchangeable spectacle kit that the user is able to interchange the lenses 10 with one single decorative frame 1. In other words, the user can change different colors of lenses 10 without purchasing additional spectacle frame. Furthermore, no tool is required to detachably mount the lenses to the decorative frame 1 and the mounting operation of the lens 10 is simple such that the user is able to replace the lenses 10 in seconds.

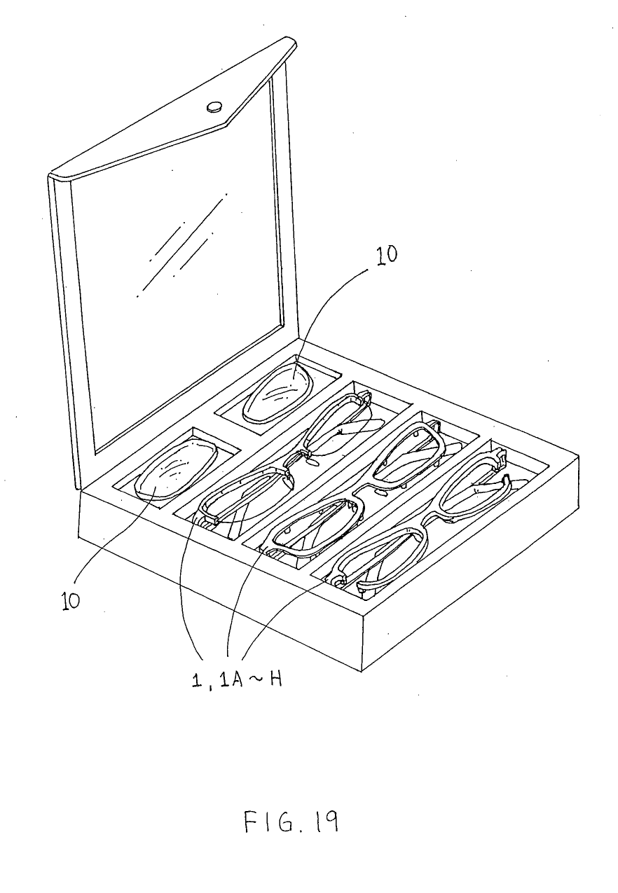

FIG. 19 illustrates another application of the spectacle set of the present invention, wherein a plurality of decorative frames 1, 1A though 1H are provided to detachably hold the lenses 10 in position, such that the user is able to interchange the decorative frames 1, 1A through 1H with the lenses 10, especially for the prescription lens.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A spectacle set, comprising at least a decorative frame and two lenses, wherein said decorative frame comprises:
two lens rims;
a bridge extended between two inner sides of said lens rims;
two side extensions provided at two outer sides of said lens rims for coupling a pair of temples respectively; and
a securing device detachably mounting said two lenses on said lens rims respectively in a toolless manner while said securing device is not observable from a front side of said decorative frame after said two lenses are mounted on said decorative frame.

2. The spectacle set, as recited in claim 1, wherein said each of said lens rims having a C-shape has two free ends arranged in such a manner that when said two free ends are aligned with each other, said lens rim form a circular structure to encircle a peripheral edge of said respective lens, wherein said securing device is provided at said free ends of each of said lens rims to connect said two free ends of said lens rim to form said circular structure.

3. The spectacle set, as recited in claim 2, wherein said securing device comprises a rim lock having an upper locking body provided at one of said free ends of said respective lens rim and a lower locking body provided at another free end of said respective lens rim, and a detachable locker having a mounting groove for said upper and lower locking body slidably receiving therein to fasten said upper locking body with said lower locking body in a detachably connecting manner so as to connect said two free ends of said lens rim.

4. The spectacle set, as recited in claim 3, wherein said upper locking body has an upper slanted surface and said lower locking body has a lower slanted surface such that when said upper locking body is overlapped on said lower locking body, a thickness of said rim lock is gradually reduced towards said lens rims, wherein said mounting groove of each of aid detachable lockers has a width gradually reducing towards an opening thereof to fit said rim lock in said mounting groove of said detachable locker.

5. The spectacle set, as recited in claim 1, wherein each of said lens rims having a C-shape has two free ends to encircle a portion of a peripheral edge of said respective lens, wherein said securing device comprises an elastic fastening string having two securing ends substantially fastening at said two free ends of each of said lens rims for applying an urging force against said peripheral edge of said respective lens so as to form a circular structure to encircle said peripheral edge of said respective lens.

6. The spectacle set, as recited in claim 5, wherein each of said lens rims forms an upper rim to encircle an upper peripheral edge of said respective lens and said elastic fastening string fastened with said respective lens rim to form a lower rim to apply said urging force against a lower peripheral edge of said respective lens so as to encircle said lower peripheral edge of said respective lens.

7. The spectacle set, as recited in claim 6, wherein each of said lenses has a retaining groove formed along said lower peripheral edge of said lens, wherein said elastic fastening string is slidably received in said retaining groove to substantially retain said lens in position.

8. The spectacle set, as recited in claim 1, wherein each of said lens rims forms a circular structure to encircle said respective lens, wherein said securing device comprises at least a supporting member upwardly extended at a lower portion of each of said lens rims for supporting a lower peripheral edge of said lens and at least a retaining member pivotally formed at an upper portion of each of said lens rims for retaining an upper peripheral edge of said lens in position, so as to substantially encircle said lens within said respective lens rim.

9. The spectacle set, as recited in claim 8, wherein said supporting member is rearwardly extended from a rear side of said respective lens rim to define a supporting groove between said supporting member and said rear side of said lens rim for said lower peripheral edge of said lens receiving in said supporting groove.

10. The spectacle set, as recited in claim 9, wherein said supporting member is inclinedly extended from said rear side of said lens rim such that a width of said supporting groove is gradually increasing towards an upper opening thereof.

11. The spectacle set, as recited in claim 8, wherein said retaining member is pivotally mounted to said rear side of said respective lens rim at said upper portion thereof, wherein said retaining member is adapted to pivotally fold to bias against said upper peripheral edge of said lens at a rear side thereof to substantially hold said lens at said lens rim and to pivotally fold offset to said upper peripheral edge of said lens such that said lens is adapted to be detached from said lens rim.

12. The spectacle set, as recited in claim 10, wherein said retaining member is pivotally mounted to said rear side of said respective lens rim at said upper portion thereof, wherein said retaining member is adapted to pivotally fold to bias against said upper peripheral edge of said lens at a rear side thereof to substantially hold said lens at said lens rim and to pivotally fold offset to said upper peripheral edge of said lens such that said lens is adapted to be detached from said lens rim.

13. The spectacle set, as recited in claim 8, wherein said securing device further comprises a protective layer formed at an inner side of each of said supporting member and said retaining member to protect said peripheral edge of said lens.

14. The spectacle set, as recited in claim 12, wherein said securing device further comprises a protective layer formed at an inner side of each of said supporting member and said retaining member to protect said peripheral edge of said lens.

15. The spectacle set, as recited in claim 8, wherein said securing device further comprises a protective layer encirclingly formed around said peripheral edge of said lens to protect said peripheral edge of said lens.

16. The spectacle set, as recited in claim 12, wherein said securing device further comprises a protective layer encirclingly formed around said peripheral edge of said lens to protect said peripheral edge of said lens.

17. The spectacle set, as recited in claim 2, wherein the securing device comprises a rim lock having an upper locking body provided at one of said free ends of said lens rim and a lower locking body provided at another said free end of said respective lens rim, and a slider locker affixed to said lower locking body to slidably engage with said upper locking body so as to connect said two free ends of said lens rim.

18. The spectacle set, as recited in claim 17, wherein said slider locker comprises a top platform rotatably mounted on said upper locking body and a bottom platform defining a locking cavity between said top and bottom platforms, wherein said slider locker is rotatably slid to lock up said upper locking body with said lower locking body when said bottom platform is slid to engage with said lower locking body to receive said upper and lower locking bodies within said locking cavity.

19. The spectacle set, as recited in claim 18, wherein said upper locking body has an upper protrusion portion and said lower locking body has a lower protrusion portion shaped and sized corresponding to said upper protrusion portion, wherein said slider locker is slid to receive said upper and lower protrusion portions within the locking cavity to lock up said upper locking body with said lower locking body.

20. The spectacle set, as recited in claim 19, wherein said securing device further comprises a reinforcing layer sandwiched between said upper and lower locking bodies.

21. The spectacle set, as recited in claim 2, wherein each of said lens rims having a L-shape cross section has a surrounding rim encircling a peripheral edge of said respective lens, wherein said securing device contains a holding groove formed along a peripheral edge of each of said lenses, wherein said surrounding rim is fittingly engaged in said respective holding groove to mount said lens within said respective lens rim.
